(19) United States
(12) Patent Application Publication
(10) Pub. No.: US 2011/0215078 A1
(43) Pub. Date: Sep. 8, 2011

(54) WINDSHIELD HEATER

(76) Inventor: Paridon Williams, Seattle, WA (US)

(21) Appl. No.: 12/718,832

(22) Filed: Mar. 5, 2010

(51) Int. Cl. B60L 1/02

(52) U.S. Cl. 219/203

(57) ABSTRACT

A windshield heater includes a substrate that is sized and shaped to cover a typical automotive windshield when placed adjacent an interior side of the windshield. The device includes one or more heating elements supported by the substrate, with the heating elements being connected to a power source to carry an electrical current or other means of producing heat throughout the heating elements. The heating elements radiate heat toward the windshield, thereby warming the windshield and either defrosting it or preventing frost from building up in the first place. The heater may include a timer and thermal control circuitry.

### FIELD OF THE INVENTION

This invention relates generally to devices for heating windshields.

### BACKGROUND OF THE INVENTION

Keeping an automobile windshield free from ice is a constant challenge that has defied solutions for decades. When the car is in operation, a defroster that operates a fan and heater powered by the car can work quite well. When the car is parked, however, the defroster is not operational and ice can build up on the windshield. This leads to a typical routine in cold weather climates in which the driver must start the car well before a desired time of departure in order to heat the windshield enough to enable the ice, frost, or snow to be removed before driving.

### SUMMARY OF THE INVENTION

In accordance with a preferred version of the invention, a windshield heater includes a substrate that is sized and shaped to cover a typical automotive windshield when placed adjacent an interior side of the windshield. The device includes one or more heating elements supported by the substrate, with the heating elements being connected to a power source to carry an electrical current or other means of producing heat throughout the heating elements. The heating elements radiate heat toward the windshield, thereby warming the windshield and either defrosting it or preventing frost from building up in the first place.

In accordance with some examples of the invention, the windshield heater is powered by the standard automobile battery, while in other versions an additional external or portable power source is provided.

In accordance with other examples of the invention, a timer is provided to enable the windshield heater to be programmed to turn on and off at desired times.

In accordance with still further examples of the invention, the substrate may be formed from relatively rigid materials such as plastic or the like, or may be formed from more flexible materials such as fabric that is supported by a more rigid frame.

In accordance with yet other examples of the invention, the substrate may be folded along pre-configured folding lines for more convenient storage.

These and other examples of the invention will be described in further detail below.

### BRIEF DESCRIPTION OF THE DRAWINGS

Preferred and alternative examples of the present invention are described in detail below with reference to the following drawings:

FIG. 1 is a front view of a preferred windshield heater;

FIG. 2 is a front view of an alternate version of a preferred windshield heater;

FIG. 3 is a schematic view of a preferred windshield heater;

FIG. 4 is a partial end view of a preferred windshield heater;

FIG. 5 is a partial sectional view of a preferred windshield heater, taken along section lines A-A in FIG. 3; and

FIG. 6 is a perspective view of a preferred heater controller.

### DETAILED DESCRIPTION OF THE PREFERRED EMBODIMENT

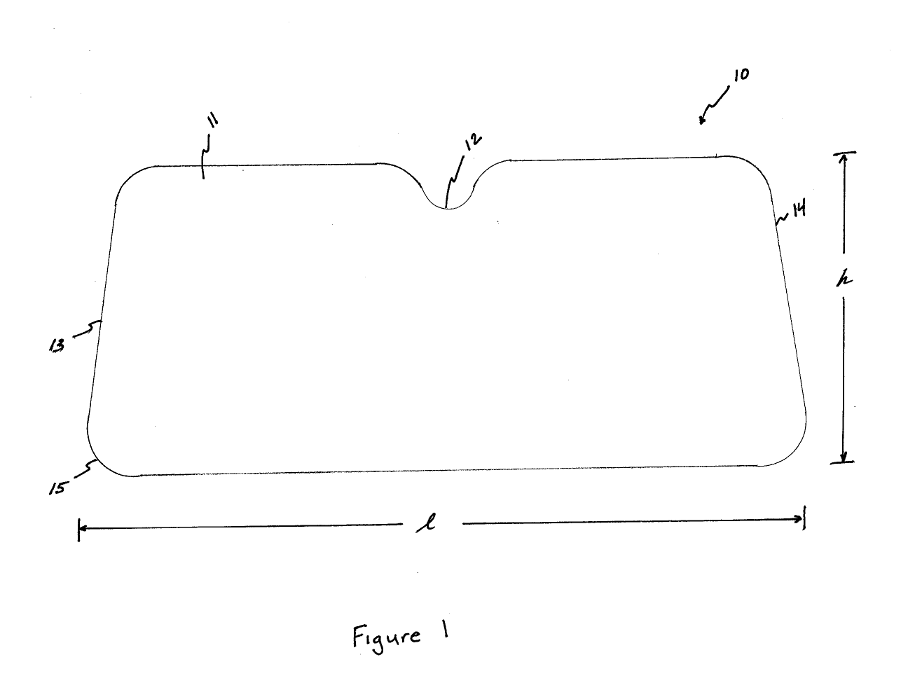

One version of a preferred windshield heater 10 is illustrated in FIG. 1. The heater is formed from a substrate 11 having an overall length/and an overall height h. The length and height may be nominal dimensions expected to allow the heater to fit snugly along the interior side of a standard automotive windshield. Windshield sizes can vary, however, and the length and width may be varied accordingly to allow the heater to accommodate cars of different sizes. Thus, the heater may be produced in a general “one size fits most” configuration, or may be tailored to fit specific models of cars.

As shown the substrate is generally trapezoidal in shape, having opposing sides 13, 14 that are inclined inward so that the top edge of the substrate is shorter than the bottom edge. This dimensional configuration is not a required aspect of the invention, but rather is intended to allow the heater to fit the configuration of an expected windshield. Likewise, the version as shown includes rounded corners 15, though in other versions the corners may be more pointed rather than rounded. At a central location along the top edge of the heater, a scalloped cutout 12 is provided. The cutout 12 is sized and configured to accommodate the placement of a typical rear-view mirror and thereby allow the substrate to fit snugly against the windshield even if a mirror is attached to the windshield.

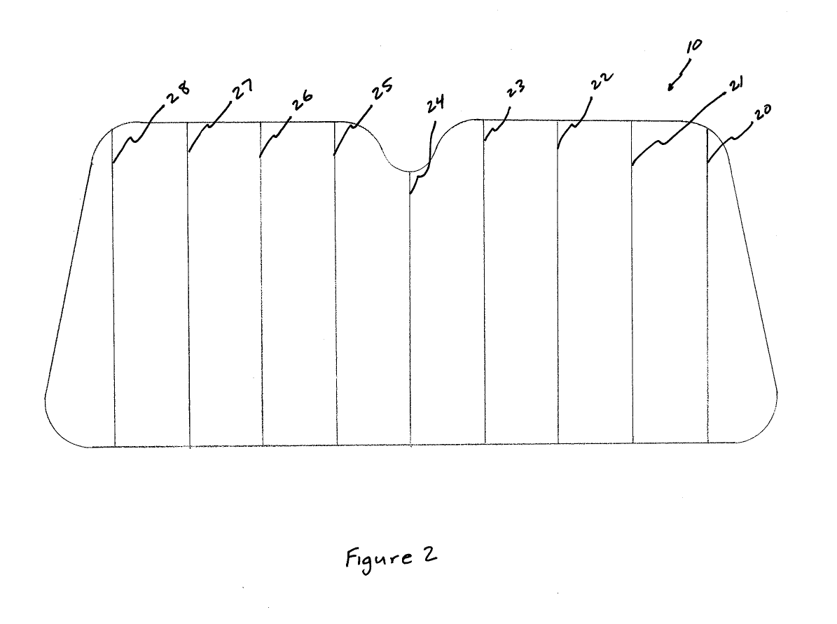

As best seen in FIG. 2, some versions of the windshield heater 10 may be foldable. In such versions, the heater substrate preferably includes a plurality of folding regions 20-28. The folding regions may be produced in a variety of ways, such as pre-folding the substrate along the folding regions during the time of manufacture or by manufacturing the folding regions of the substrate with thinner or otherwise weakened material to facilitate folding. Most preferably, the windshield heater is folded and packaged in a folded position for more convenient shipping and storage.

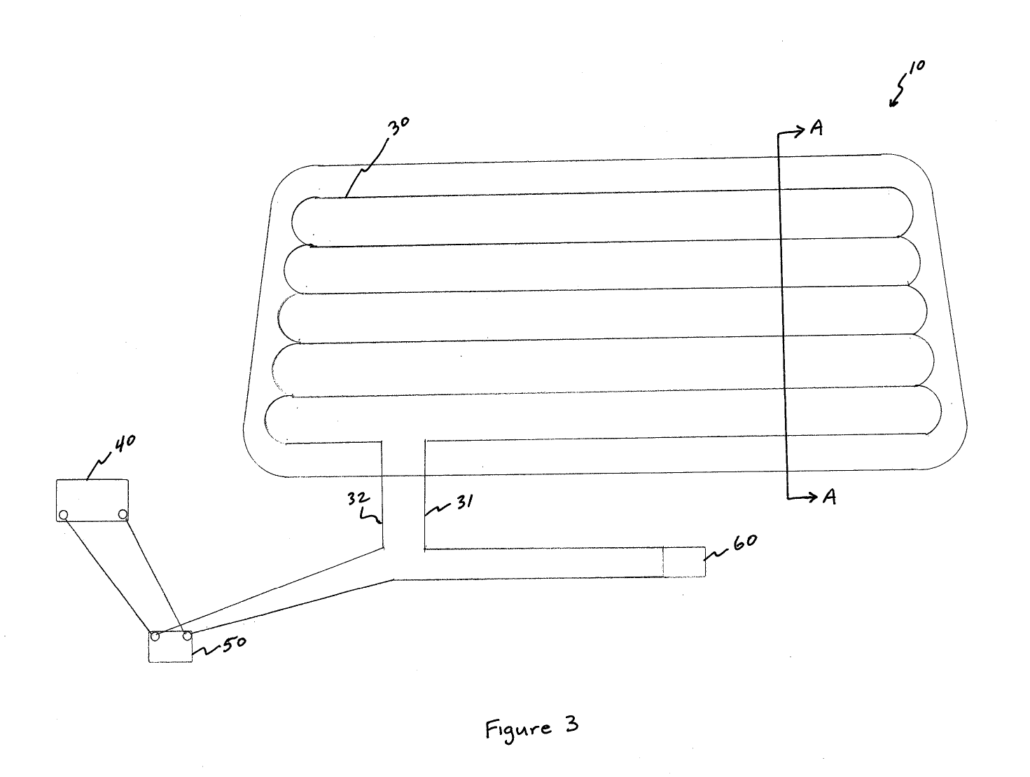

FIG. 3 provides a schematic view of a preferred windshield heater 10. As shown, the windshield heater includes a plurality of heating elements 30 forming a grid. In a preferred version the grid of heating elements is formed from nichrome resistance heating wire such as NiCR60. Nichrome wire is a preferred choice because it is corrosion resistant and withstands high temperatures. Other materials are may also be suitable, though in the preferred version of the invention the heating elements 30 are formed from a resistance wire which produces heat from an electrical current flowing through the wire.

In the schematic view as shown, a grid is formed from six rows of heating elements extending substantially parallel to one another and running lengthwise from one side to the other within the substrate. In alternate versions, a larger or smaller number of rows is provided, depending on the gauge of the wire chosen and the amount of heat desired to be produced. Likewise, the grid of wires need not extend in a lengthwise fashion as shown, but may alternatively extend from the top edge to the bottom edge or in any other direction that will produce heat across the majority of the surface of the substrate.

The grid of wires may be configured in several optional versions, as desired. In one version, the grid of wires may be formed from a single wire running continuously in a raster fashion or otherwise winding its way through the substrate. In other versions, several wires may be joined to provide parallel current flow paths across the substrate.

A power source 40 is used to provide electrical current to produce heat within the grid of heating elements. The power source includes positive and negative terminals which are connected to a controller 50. The controller is connected to a thermal switch 60. One terminal from the power source and timer is connected to a first lead line 32 from the grid 30, while a second lead line 31 from the grid 30 is connected to a terminal from the thermal control switch 60.

In one version of the invention, the power source 40 is the 12 volt battery that is standard with the car. In a preferred example, the windshield heater is connected to the battery by a standard 12 volt plug configured to be inserted into a standard automotive accessory socket (sometimes referred to as a cigarette lighter). In such a version, the 12 volt plug will include lead wires connecting the power socket to the controller 50, as shown in FIG. 3.

In an alternate version of the invention, the power source is a dedicated power source that accompanies the windshield heater, rather than being the car battery. Depending on the material, length, and gauge of the heating grid, the power source may be chosen accordingly. The power source may be, for example, a 6 volt battery or a plurality of batteries as appropriate to produce the desired level of current. In such a version, the battery (or batteries) is preferably housed in a case (not shown) that includes the controller and thermal control switch.

In yet other versions the power source may comprise an a/c power source such as is available at a standard wall outlet. In such a version, the power source may include a transformer as appropriate to convert the a/c power to d/c and to step it up or down to a desired level to produce the desired amount of current.

The controller 50, in its simplest form, is merely an on-off switch that closes the circuit to allow current to flow from the power source and through the grid of wires. In alternate versions of the invention, the control switch includes a timer that allows the circuit to be closed (and therefore the heater to be “on”) at a particular time and for a particular duration. In one form, the timer is simply a count-down timer that turns on the heater after a particular time that is settable by the user. For example, the user may set the timer to 12 hours, after which the heater circuit is closed and current will flow for a user-settable length of time, for example one hour.

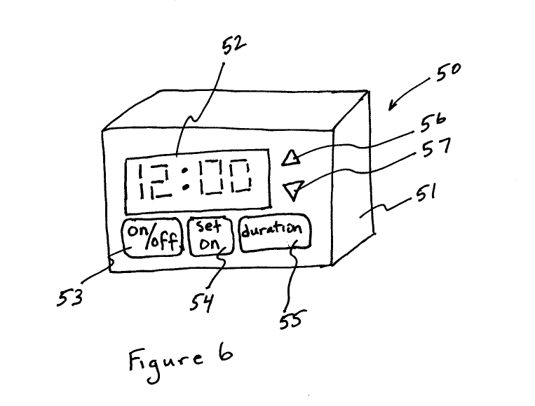

A perspective view of a preferred controller 50 is shown in FIG. 6. The display 50 includes a housing 51 that is formed from plastic or other suitable materials. An external surface of the housing includes a display 52. In the version as shown, the display is an LED or LCD display configured to be able to at least display a time of day. Other display types are also possible, including displays that are much larger and configured to display a current time, start time, duration, and other indicators simultaneously. Although not shown, the display further includes an internal processor and memory containing stored programming instructions allowing the user to operate the display controls and to store desired start and duration times.

The display includes one or more user input devices, and as shown the input devices are in the form of buttons. The buttons may include a first button 53 that serves as a power on/off switch, allowing the user to simply turn on the heating unit to begin current flow through the grid of wires.

A second button 54 is labeled “set on” and allows the user to set a desired time at which the heater will turn on. The set on button may also be programmed to allow the user to set the time in the first instance, or to set a desired time at which the heater will turn off. Once the second button 54 is pressed, the user can use a pair of up/down buttons 56, 57 to increment or decrement the time presented in the display that indicates the time at which the heater will turn on. As the user scrolls up or down past 12:00, the stored programming instructions preferably include an “off” indicator to represent that the heater is not programmed to turn on at any time. After a preset timeout period, the display reverts to the presentation of the current time of day. It should be appreciated that the controller as shown in FIG. 6 may be varied greatly in accordance with the invention in order to facilitate adjustable control of the windshield heater.

Though not shown in FIG. 6, the controller includes a pair of lead wires as shown in FIG. 3. As desired, the lead wires may be of any suitable length to allow the controller to be either secured directly to the substrate or extended away from the substrate as desired.

The controller and the grid of wires are in electrical communication with a thermal control switch 60. The thermal control switch is used to monitor the temperature of the windshield heater and to enable or disable the electrical flow accordingly, depending on temperature conditions. Most preferably, the thermal control switch is preconfigured to limit current flow through the grid of wires to prevent the windshield heater from reaching temperatures above a desired maximum.

A third button 55 is labeled “duration” and allows the user to set the number of minutes that the heater will remain on after switching on at the preset time. Thus, if the user presses the duration button, the user may then press the up/down buttons 56, 57 as appropriate to increment or decrement the amount of time indicated on the display. The indicated time will then be used for the duration for which the heater remains on. After that time has elapsed, the controller automatically shuts off the heater.

In more sophisticated versions, the controller includes a real-time clock with a display. One or more buttons allows a user to set a desired initiation time when the heater will turn on, and also to allow a user to set a desired length of time during which the heater will remain on after it is initially turned on.

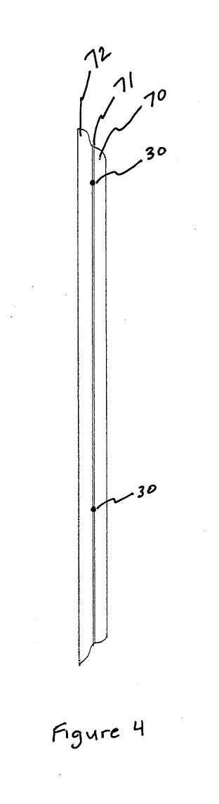

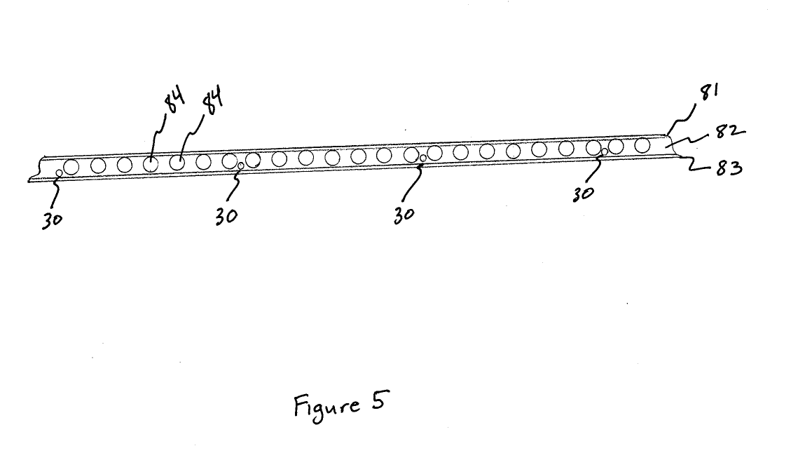

The construction of the substrate is most clearly seen with reference to FIGS. 4 and 5. In one version, as shown in FIG. 4, the grid of wires 30 are sandwiched between opposing layers 70, 72 of relatively rigid material. An optional middle layer 71 may be provided, in which the middle layer is an adhesive or plastic layer laminated between the opposing outer layers 70, 72. The opposing outer layers may be formed from plastic, glass, fiberglass, Mylar, silicone, or any other material that is able to support the grid of wires and withstand the heat produced by the wires without igniting.

Likewise, the substrate may be formed from one or more layers of fabric that is bordered by a rigid frame for structural support. Any nonflammable or highly flame resistant fabric may be used for the substrate, with the grid of wires adhered to the substrate using glue, stitching, weaving, or any other means.

Another preferred construction is shown in FIG. 5, in which the substrate is formed from a corrugated plastic material that is heat and flame resistant. The construction as shown includes an interior corrugated plastic layer 82 having a plurality of air channels 84. The outside surfaces of the substrate may include a Mylar layer 81, 83, which may be reflective if desired. The grid of wires 30 preferably is embedded within the interior corrugated plastic layer, though in alternate embodiments it may be mounted to one surface of the substrate. In a version in which the grid of wires is embedded within the plastic layer as shown in FIG. 5, preferably the wires are positioned more closely adjacent one surface or the other of the plastic layer, rather than being centrally located. Thus, the first surface (or layer 81) is designed to face the interior of the car cabin while the second surface (or layer 83) is designed to be placed against the windshield. In such a configuration, the grid of wires is more closely positioned adjacent the second surface.

In use, the windshield heater is placed in a car adjacent the windshield. In the simplest application, the power is turned on to allow current to flow and heat to be produced. The heat radiates toward the windshield, thereby warming the windshield and facilitating the removal of ice or frost, or preventing buildup in the first place. In versions that include a time-based controller, the user may position the windshield heater in place adjacent the windshield and allow it to automatically turn on at a desired time and for a desired duration. For example, it may be placed against a windshield at night and programmed to automatically turn on in the morning at a desired time before departure. This allows the windshield to be frost-free without the need to start the car early in order to defrost the windshield.

While the preferred embodiment of the invention has been illustrated and described, as noted above, many changes can be made without departing from the spirit and scope of the invention. Accordingly, the scope of the invention is not limited by the disclosure of the preferred embodiment. Instead, the invention should be determined entirely by reference to the claims that follow.

The embodiments of the invention in which an exclusive property or privilege is claimed are defined as follows:

1. A windshield heater, comprising
a substrate being configured to fit adjacent an automobile windshield and further being sized to substantially cover an interior surface of the windshield, the substrate having a first surface for placement toward the windshield and a second surface for placement away from the windshield; and
a heating element supported by the substrate, the heating element being configured to radiate heat toward the windshield when the substrate is positioned adjacent the windshield.

2. The windshield heater of claim 1, wherein the heating element further comprises a resistive wire.

3. The windshield heater of claim 2, wherein the resistive wire is formed from nichrome.

4. The windshield heater of claim 2, wherein the resistive wire forms a grid of wires.

5. The windshield heater of claim 4, further comprising a power source and a thermal switch in electrical communication with the power source and the grid of wires, whereby the thermal switch regulates an electrical current flowing from the power source and through the grid of wires.

6. The windshield heater of claim 5, further comprising a controller coupled to the power source, the controller being configured to selectively enable or disable the current flowing from the power source and through the grid of wires.

7. The windshield heater of claim 6, wherein the controller further comprises a display, one or more buttons, a processor, and a memory, the memory containing stored programming instructions operable by the processor to allow the display to present a time of day.

8. The windshield heater of claim 7, wherein the stored programming instructions further cause the processor, in response to inputs received by the one or more buttons, to store a time of day and a duration, wherein the controller will allow current to flow from the power source and to the grid of wires beginning at the stored time of day and continuing for the stored duration.

9. The windshield heater of claim 4, wherein the substrate is formed from heat-resistant plastic.

10. The windshield heater of claim 9, wherein the substrate is further formed from a corrugated material.

11. The windshield heater of claim 10, further comprising a coating layer on at least one of the first surface or the second surface.

12. The windshield heater of claim 9, further comprising a plurality of folding regions.

13. The windshield heater of claim 4, wherein the substrate comprises a peripheral frame defining an interior region, the interior region comprising a flexible material supported by the peripheral frame.

14. The windshield heater of claim 13, wherein the flexible material comprises a fabric.
